(19) United States
(12) Patent Application Publication
(10) Pub. No.: US 2007/0052886 A1
(43) Pub. Date: Mar. 8, 2007

(54) Contact lenses with selective spectral blocking and method of fabrication thereof

(76) Inventors: Bunsen Fan, Cortlandt Manor, NY (US); Michael Chang, Los Angeles, CA (US)

Correspondence Address: REVEO, INC., 3 WESTCHESTER PLAZA, ELMSFORD, NY, 10523, US

(21) Appl. No.: 11/388,222

(22) Filed: Mar. 23, 2006

Related U.S. Application Data
(60) Provisional application No. 60/664,706, filed on Mar. 23, 2005.

(51) Int. Cl. G02F 1/1335

(52) U.S. Cl. 349/98

(57) ABSTRACT

Provided herein is an ophthalmic lens and methods for making an ophthalmic lens. The ophthalmic lens includes a body having one or more films having at least one spectral reflection band. The reflection band includes spectral reflection properties to reflect right handed circularly polarized light, left handed circularly polarized light, or a combination of right handed circularly polarized light and left handed circularly polarized light.

### RELATED APPLICATIONS

This application claims the benefit under 35 U.S.C. §119(e) of U.S. Provisional Application No. 60/664,706 filed on Mar. 23, 2005, which is incorporated by reference.

### TECHNICAL FIELD

The present invention relates to ophthalmic contact lenses and more particularly to contact lenses whose transmission can be blocked by reflection in band or bands over a spectral range from ultraviolet to infrared.

### BACKGROUND ART

At present, contact lenses are a convenient eyewear format either for vision correction or cosmetic use. As UV radiation is likely a cause of cataracts and senile macular degeneration, UV-blocking contact lenses are desirable. Contact lenses that block UV by means of absorption are commercially available and find increasing popularity.

However, contact lenses that block visible and infrared light are difficult. Typically, light blocking is achieved by either absorbing or reflecting the light of interest. It is difficult to conventionally deposit a multi-layer dielectric coating on plastic contact lenses, as their surface typically has a large radius of curvature. In addition, coating deposition on flexible soft contacts, which are the most popular, is challenging, as the so called “hydrogel” lens materials contain more than 50% water. Coating adhesion may be an issue to overcome. The other approach of using absorptive dyes doping may not be easy. The absorbing dyes may leach out in the aqueous environment of the eye or when stored in a saline solution. The safety profile of absorbing dyes could also be a health issue. A viable alternative is to incorporate dyes that can be co-polymerized with hydrogel polymers. However, synthesis of such absorbers is technically difficult. In addition, other impacts on the contact lenses, such as durability, flexibility, hydrophilicity and stability to sterilizing regiments, are uncertain. Thus, a need exists for a contact lens for improved performance.

Therefore, a need remains in the art for ophthalmic contact lenses that selectively blocks the transmission of incident light. Further, a need remains in the art for methods to fabricate these ophthalmic contact lenses that selectively blocks the transmission of incident light.

### BRIEF SUMMARY OF THE INVENTION

Provided herein is an ophthalmic lens and methods for making an ophthalmic lens. The ophthalmic lens includes a body having one or more films having at least one spectral reflection band. The reflection band includes spectral reflection properties to reflect right handed circularly polarized light, left handed circularly polarized light, or a combination of right handed circularly polarized light and left handed circularly polarized light.

### BRIEF DESCRIPTION OF THE FIGURES

The foregoing summary as well as the following detailed description of preferred embodiments of the invention will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings, where:

FIGS. 1A-C schematically illustrates elevational cross-sections certain embodiment, in accordance with the invention;

FIGS. 2A-C schematically illustrates elevational cross-sections of further embodiments, in accordance with the invention;

FIG. 3 schematically illustrates an elevational cross-section of another embodiment, in accordance with the invention;

FIGS. 4A-D graphically illustrates the reflection properties of a right-handed cholesteric liquid crystal film;

FIG. 5 illustrates the geometry of a notch filter or mirror using a pair of cholesteric liquid crystal films; and

FIG. 6 graphically illustrates an apparatus for fabricating curved film.

### DETAILED DESCRIPTION OF THE FIGURES

Ophthalmic contact lenses that selectively blocks the transmission of incident light are proposed herein. Further, methods to fabricate these ophthalmic contact lenses are proposed.

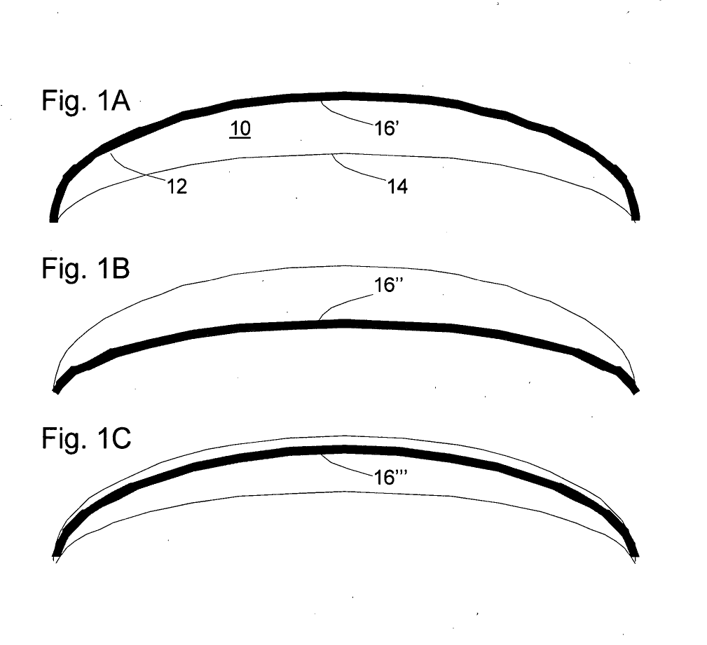

According to certain embodiments of the invention, a polymeric cholesteric liquid crystal (CLC) film is incorporated on the surface of or within the body of an ophthalmic contact lens. The body 10 may be formed of conventional ophthalmic lens material such as polymethyl methacrylate (PMMA) and acrylates, or non-conventional materials such as liquid crystal blends as described herein. FIGS. 1A-C graphically illustrates a contact lens 10 having an anterior surface 12 and a posterior surface 14 that incorporates one or more polymeric CLC films 16. The light blocking is achieved by bonding a reflective CLC film 16′ on the anterior surface 12 (FIG. 1A) of the contact lens body 10, bonding a reflective CLC film 16″ on the posterior surface 14 (FIG. 1B) of the contact lens body 10, or imbedding the film 16′″ within the contact lens body 10 (FIG. 1C). The light-blocking CLC film 16 can be incorporated on both soft and rigid/hard contact lenses, which are well-known to those skilled in the art.

The CLC film 16 is prepared to exhibit a wavelength- and polarization-selective reflection band. The film 16 is highly transparent, that is, it transmits freely light outside the reflection band without absorption and scattering. In addition, the film 16 is of high optical quality; it does not impair visual performance or create distractions in the visual field.

A CLC film is a self-organized stack of molecular layers. Each molecular layer comprises of typically calamitic (rod-like) molecules that align themselves more-or-less in a common direction, defined as the “director.” These structurally ordered molecular layers, in turn, are rotated slightly at a constant angle from one layer to the next, either clockwise or counterclockwise. This spatial variation of the director leads to a spiral or helical structure. The helical axis orients naturally normal to the surface of the film, in the Grandjean texture. This helical planar configuration gives rise to the unique wavelength- and polarization-selective reflection, due to optical interference effects. The reflection is near 100% for circularly polarized incident light, if the film has about 10 pitches or more. For visible-reflecting films, it is ˜5-˜10 μm thick.

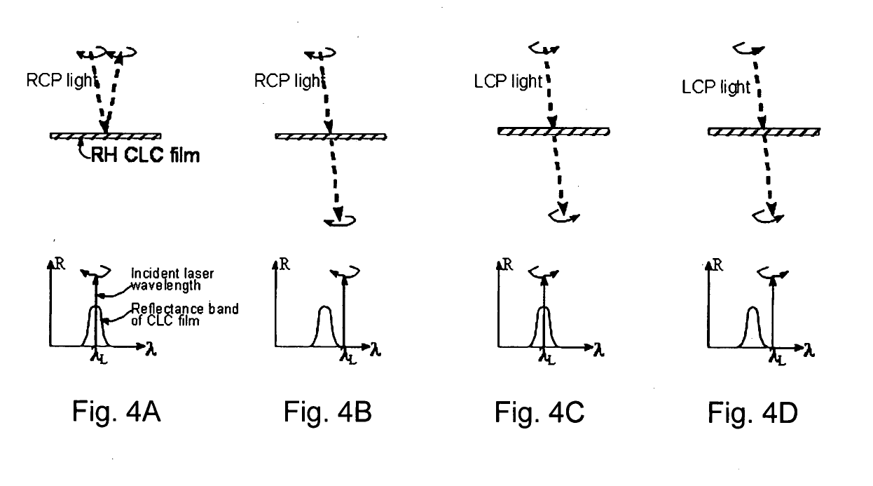

CLC blends can be formulated to form either a left-handed (LH) helix or a right-handed (RH) helix with its reflection band tunable anywhere from ultraviolet to infrared. The handedness, or chirality, is set, for example, by the chiral agents in a nematic liquid crystal blend. A film with a RH helical pitch selectively reflects right-circularly polarized (RCP) light while transmitting freely left-circularly polarized (LCP) light. A LH helical pitch film does the opposite. FIGS. 4A-4D graphically illustrates the reflection properties of a RH CLC film. The film reflects ˜100% RCP light if its wavelength is within the reflection band (FIG. 4A). The film transmits ˜100% the RCP light if it is outside the band (FIG. 4B). The film transmits ˜100% LHP light if it is inside the band (FIG. 4D). The film also transmits ˜100% LHP light if it is outside the band (FIG. 4D).

Typically, thermotropic CLCs exhibit this selective reflection over a limited temperature range. The reflection band may also shift either to a shorter or longer wavelength as temperature changes. In addition, the film structure is unstable with respect to outside environmental perturbations, such as chemicals. With the advances in CLC polymers, the CLC molecules in the film can be cross-linked or polymerized to form a stable glassy structure that retains the selective reflection “permanently.” In addition, polymerized CLC films are thermally, chemically and mechanically stable. This, in turn, facilitates stacking a pair of spectrally matched RH and LH films to form a compound CLC film, known as an optical notch filter or mirror. With reference to FIG. 5, the combined effect is that the incident light in the band is reflected totally and the light outside the band is transmitted totally, as unpolarized, linearly polarized or elliptically polarized light is a superposition of RCP and LCP components. A notch filter with two rejection bands can be constructed by stacking two different CLC film stacks. Such CLC film stack is useful for contact lens that blocks two spectral bands of the incident light, for example, both UV and IR.

Typically, CLC films exhibit a rather narrow bandwidth as the bandwidth Δλ is determined by the material properties of the CLC blend, according to,
Δλ≈(Δn/nₐᵥ)λ_{c} (1)
where λ_{c} is the center wavelength of the reflection band. The averaged index of refraction nₐᵥ=(nₑ+nₒ)/2, with nₑ and nₒ denoting the extraordinary and ordinary index of refraction of the CLC. The optical birefringence Δn=nₑ−nₒ. The center wavelength, λ_{c}, is given by
λ_{c}≈nₐᵥP₀ cos θ (2)

where P₀ is the helical pitch, the length for the director to rotate 360°, and θ is the angle of incidence. With typical values of nₐᵥ˜1.55 and Δn<0.1, the intrinsic bandwidth amounts to a range of 20-100 nm. For some applications, such narrow bandwidth is preferable. For example, contact lenses incorporating such film can adequately block single-wavelength laser radiation. For some applications, the intrinsic bandwidth is insufficiently wide. For example, for eye protection against UV radiation, the coverage should be the entire UVA region (400-320 nm). Another example is for eye protection against infrared laser radiation, the coverage is preferable over a spectral range from 800 nm to 1,200 nm and beyond.

There are several schemes to achieve a broad reflection band. Stacking several narrowband CLC films can form a composite broadband filter. The preferred means to fabricate broadband CLC films for the inventive contact lenses is disclosed in U.S. Pat. No. 5,691,789 by Li et al. and incorporated by reference herein By proper material blending and film processing techniques, single-layer films have a helix pitch that gradually monotonically increases or decreases across the film. Typically, the CLC blends comprises of a reactive component and non-reactive component. The reactive LC component is typically a photo-crosslinkable polymer. The non-reactive LC component is usually of low-molecular-weight (LMW) types. When the film is polymerized under certain conditions, change in miscibility causes a gradual variation in material composition across the film. This, in turn, results in a non-uniform nₐᵥ and/or local helical pitch P₀. Such film structure exhibit a much broader bandwidth, compared to that of a film with a constant pitch. It can be understood that the broadband film can be considered as a stack of many thin films with a changing center wavelength of its reflection band, governed by
λ_{c}(z)≈nₐᵥ(z)P₀(z)cos θ(2a)
where z denotes the distance from the film surface. The reflection properties of such films are often requires numerical simulations. For example, Berreman's 4×4-matrix formulation can adequately be used for such purpose.

The broadband CLC formulations generally comprise two main components, a photo-crosslinkable polymer and a LMW LC. Liquid crystal polymers cholesteric or nematic compounds, such as polysiloxanes from Wacker Chemie GmbH, Munich, Germany and diacrylates from BASF Aktiengesellschaft, Ludwigshafen, Germany are useful as a reactive component. The LMW LC compounds and chiral dopants from EM Industries, Hawthorne, N.Y. are useful as a non-reactive component. It is clear to those skilled in the art that other liquid crystal polymers and LMW liquid crystal compounds can be used to formulate CLC blends for contact lens of the invention.

For the inventive contact lenses, the CLC films are preferred to be mechanically robust, chemically inert and porous in structure. Porosity of the CLC films is essential for good oxygen circulation to the cornea of the eye. The preferred means to fabricate porous CLC films is disclosed in U.S. Pat. No. 6,106,743 by Fan et al. and incorporated by reference herein. Briefly, the process involves removal of components from and, optionally, addition of other components to a polymerized CLC film, while maintaining the selective reflection for the resulting film. The process is symbolically represented by
A+B→(A+B)−B→A+C→. . . (4)
where A, B and C represent various material components of the film during processing. Initially, a blend of components comprising of A and B is formulated. Using the broadband CLC film as a teaching example, A is the reactive component, that is, cross-linkable polymer. B is the non-reactive component, that is, the LMW LC. After a film is prepared with the blend, the non-reactive component B is removed. The resulting film is a porous polymeric matrix of component A that still retains the ordered structure that exhibit wavelength- and polarization-selective reflection that is a unique characteristic of CLC films. The voids, which are at locations previously occupied by the B component, are at the mesogenic scale in size. The selective reflection band is shifted to a shorter wavelength. Since the void size is much smaller than the optical wavelength, the porous film does not show scattering. If necessary, the voids in the film can be filled, partially or fully, by a new component C. which is not necessary a liquid crystal at all. The film then comprises of components A and C. The resulting film still exhibits wavelength- and polarization-selective reflection that is a unique characteristic of CLC films. The selective reflection band is shifted to a longer wavelength. The process making the CLC films porous can also apply to narrowband CLC films.

The utility of the process for making the CLC films porous for the inventive contact lenses becomes apparent now. The non-reactive component used to broaden the reflection band is removed as the B-component. The resulting film is all-polymeric, and thus more stable and chemically inert. Most CLC films are hydrophobic, and typically the porosity of the processed CLC film ensures its high gas permeability. The CLC film can also be further optionally processed to become hydrophilic. The voids can then be filled with water (a main component of eye tear) as the C-component and the film still remains highly gas permeable. To achieve this, the voids can be partially filled with a polymer having hydrophilic groups to make the film hydrophilic. Chemical compounds and techniques for incorporating such are disclosed in U.S. Pat. No. 5,130,024 which is incorporated by reference herein.

Returning to FIG. 1, there are three configurations for contact lenses of the invention. One embodiment of the invention, shown in FIG. 1A, is to attach the reflective CLC film on the anterior surface of the lens body. A pre-fabricated CLC film is bonded to the surface of the lens or a CLC film is directly fabricated on the surface of the lens. This anterior configuration is highly desirable, as the film can be added to the contact lens after it is manufactured in the usual manner, which is well known to those skilled in the art.

Another embodiment of the invention, shown in FIG. 1B, is to attach the reflective CLC film on the posterior surface of the lens body. This posterior configuration is also highly desirable, as the film can be added to the contact lens after manufacturing in the usual manner. In addition, the posterior surface has a nearly constant radius of curvature; the fabrication of CLC films would be much simpler logistically. As the CLC film is in contact with the cornea, it must provide sufficient lubrication with the cornea. Being typically hydrophobic, the film may adhere too well to the cornea. Thus, it requires treatment of the film surface, so it can move freely on the eye and allow tear flow between the contact lens and eye. One way is to make the surface to be hydrophilic with plasma treatment, as disclosed in the U.S. Pat. Nos. 4,312,575 and 4,632,844, both of which are incorporated by reference herein.

A further embodiment of the invention, shown in FIG. 1C, is to embed the reflective CLC film within the lens body. This embedded configuration can be fabricated by dividing the lens body into two parts and sandwiching the film between the two body parts. Other fabrication approaches can be taken to achieve this embedded configuration.

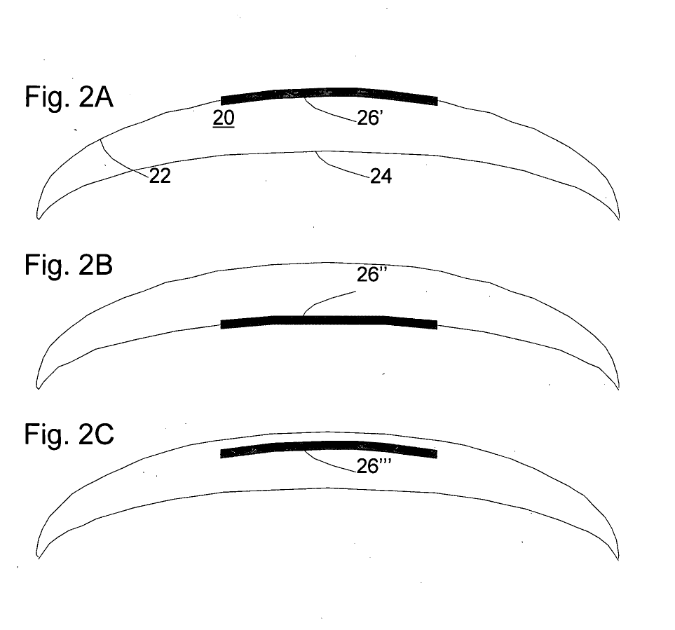

The CLC film does need to cover the entire lens for effective light blocking. FIGS. 2A-C illustrates another embodiment of the invention. FIGS. 2A-C graphically illustrates a contact lens 20 having an anterior surface 22 and a posterior surface 24 that incorporates one or more polymeric CLC films 26. A CLC film covers the opening of the eye pupil in the ocular region. The light blocking is achieved by bonding a reflective CLC film 26′ on the anterior surface 22 (FIG. 2A) of the contact lens body 10, bonding a reflective CLC film 26″ on the posterior surface 24 (FIG. 2B) of the contact lens body 10, or imbedding the film 26′″ within the contact lens body 20 (FIG. 2C).

For contact lens of the invention, the CLC films are curved as shown in FIG. 1 for optimal blocking performance. There are two preferred methods to fabricate such films. The first is to utilize curved substrates, as disclosed in U.S. Pat. No. 5,061,046 which is incorporated by reference herein. FIG. 6 illustrates a suitable apparatus 60, comprising a set of substrates including a substrate 62 having a concave film shaping surface 63 and a substrate 64 having convex film shaping surface 65. The radii of curvature of the facing surfaces, R₃ₐ and R_{3b}, are nearly equal for a CLC film of substantially uniform thickness. Note that if a varied thickness of the CLC film is desired, one may vary the radii of curvature of the facing surfaces, R₃ₐ and R_{3b} appropriately. One of the substrates is substantially transparent to let the polymerization light to pass through. The facing surfaces are first coated with a release layer, e.g., several microns thick, using spin-coating, spraying or other convenient means. The function of the release layer is to easily separate the polymerized CLC film from the substrates. Preferably, the release layer is of a material that does not interact chemically with the liquid crystal material and can be dissolved in a solvent, such as water. Polyvinyl alcohol (PVA) is one example. The release layer is then over-coated with a thin alignment layer such as polyimide, if necessary, to produce a CLC film with Grandjean texture. It is noted that the procedure is similar to the manufacturing of liquid crystal displays (LCDs). The alignment layer is mechanically buffed with a nylon pile. The surface-treated substrates are formed into a cell, with spacers 66 at peripheral to set the film thickness. The liquid crystal blend is then introduced into the cell gap between the substrates, for example, by capillary action or vacuum suction. After shearing and annealing, the film is then polymerized in the manner taught earlier. The CLC film is then separated from substrates to form a freestanding film.

This process is used to fabricate a pair of RH and LH CLC films with substantially matched reflection bands in spectral range. The paired films are then stacked and bonded. In certain embodiments, it may be desirable to use the same CLC blend (either of LH or RH blends or mixture of them) as a bonding agent. The bonding layer is polymerized at or above the clearing temperature of the CLC blend (the temperature at which the transition between the mesophase with the highest temperature range and the isotropic phase occurs). The bonding layer is then optically isotropic. The advantage of using the same CLC blend for bonding is to achieve matching in the refractive index and porosity. The compound reflecting film can then later be processed to become porous by removing the non-reactive component. Notably, by using the same CLC blend as the film (either LH, RH or a mixture thereof), the porosity characteristics remain consistent throughout the composite. The reflecting CLC film stack is then integrated with a contact lens, in accordance with teachings related to FIG. 1. Contact lenses in accordance with the present invention may be hard lenses or rigid gas permeable (RGP) lenses, as well as “soft” lenses, which are well known to those skilled in the art.

The second preferred method to fabricate curved CLC films using one substrate. This process is highly advantageous, as the CLC film can be directly fabricated on the surface of pre-fabricated contact lenses. A thick CLC film is applied on a curved substrate, either by directly spin coating or knife-edge coating. The surface of the substrate is similarly treated to produce a CLC film with Grandjean texture. After annealing, the film is then polymerized in the manner taught earlier. Polymerization preferably takes place in an environment without the presence of atmospheric oxygen, which acts as an inhibitor.

As before, this process is used to fabricate a pair of RH and LH CLC films with substantially matched reflection bands in spectral range. The paired films are then stacked and bonded. It is preferable to use the same CLC blend (either of LH or RH blends or mixture of them) as a bonding agent. The bonding layer is polymerized at or above the clearing temperature of the CLC blend. The bonding layer is then optically isotropic. The advantage of using the same CLC blend for bonding is to achieve matching in the refractive index and porosity.

The film stack can be fabricated sequentially. For example, a RH CLC film is first fabricated on the curve substrate. Then a spectrally matched LH CLC film is fabricated on the RH CLC film, forming a paired stack. The compound reflecting film can then later be processed to become porous by removing the non-reactive component. The reflecting CLC film stack is then integrated with a contact lens, in accordance with teachings related to FIG. 1.

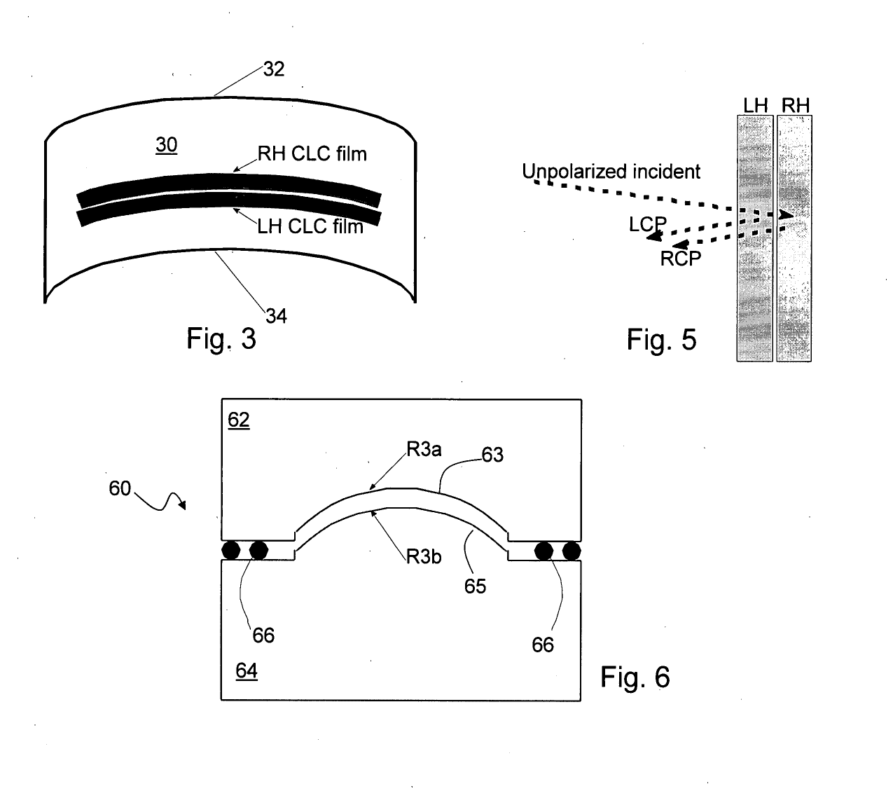

Turning to FIG. 3, another embodiment of present invention uses with the same CLC material (either of LH or RH blends or mixture of them) for the lens body 30. The lens body 30 is polymerized at or above the clearing temperature to be optically isotropic. As shown, the lens if formed with an anterior surface 32 with a radius of curvature R1, and a posterior surface 34 with a radius of curvature R2. The advantage of using the same CLC blend for lens body becomes apparent. In addition to close matching in the refractive index through the lens, the entire lens can be porous by removing the non-reactive component as described above with respect to equation (4). Note that the same material can be used for the lens body in any of the configurations described above with respect to FIGS. 1A-2C.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. An ophthalmic lens comprising:
an ophthalmic lens body having one or more films having at least one spectral reflection band, the reflection band having spectral reflection properties to reflect right handed circularly polarized light, left handed circularly polarized light, or a combination of right handed circularly polarized light and left handed circularly polarized light.

2. The ophthalmic lens as in claim 1, wherein the one or more films having a reflection band include films formed of cholesteric liquid crystal materials.

3. The ophthalmic lens as in claim 1, wherein the one or more films having a reflection band include a first film formed of cholesteric liquid crystal materials having right handed ordering thereby reflecting right handed circularly polarized light within the spectral band and a second film formed of cholesteric liquid crystal materials having left handed ordering thereby reflecting left handed circularly polarized light within the spectral band.

4. The ophthalmic lens as in claim 1, wherein the one or more films having a reflection band include films formed of polymeric material having cholesteric liquid crystal ordering.

5. The ophthalmic lens as in claim 1, wherein the one or more films having a reflection band include a first film formed of polymeric material having cholesteric liquid crystal ordering having right handed ordering thereby reflecting right handed circularly polarized light within the spectral band and a second film formed of polymeric material having cholesteric liquid crystal ordering having left handed ordering thereby reflecting left handed circularly polarized light within the spectral band.

6. The ophthalmic lens as in claim 1, wherein the one or more films are porous.

7. The ophthalmic lens as in claim 1, wherein the one or more films cover a portion of the ophthalmic lens body.

8. The ophthalmic lens as in claim 7, wherein the portion of the ophthalmic lens body covered by the one or more films corresponds to a position of a cornea of a wearer of the ophthalmic lens.

9. The ophthalmic lens as in claim 1, wherein the one or more films have substantially uniform thickness.

10. The ophthalmic lens as in claim 1, wherein the ophthalmic lens is formed of material similar to the material for the one or more films substantially without spectral reflection properties.

11. The ophthalmic lens as in claim 1, wherein the ophthalmic lens is formed of polymethyl methacrylate or acrylates.

12. A method of fabricating an ophthalmic lens comprising:
providing a ophthalmic lens body; and
integrating one or more films having at least one spectral reflection band with the ophthalmic lens body.

13. The method as in claim 12, wherein the one or more films are integrated by attaching to the anterior of the ophthalmic lens body.

14. The method as in claim 12, wherein the one or more films are integrated by attaching to the posterior of the ophthalmic lens body.

15. The method as in claim 13, further comprising treatment of the film surface to impart hydrophilic properties.

16. The method as in claim 12, wherein the one or more films are integrated by embedding the one or more films within the ophthalmic lens body.

17. A method of fabricating an ophthalmic lens comprising:
providing a ophthalmic lens body;
forming one or more films having at least one spectral reflection band; and
integrating one or more films having at least one spectral reflection band with the ophthalmic lens body.

18. The method as in claim 17, wherein forming said one or more films comprises:
providing a set of substrates having concave and convex film shaping surfaces, wherein at least one of the substrates is substantially transparent to permit polymerization light to pass through;
coating the film shaping surfaces of the substrates with a release layer;
over-coating the release layer with an alignment layer;
forming a cell with the surface-treated substrates are formed a cell,
optionally including spacers at peripheral edges to set the film thickness;
introducing a liquid crystal blend into a cell gap between the substrates;
shearing;
annealing;
polymerizing;
separating the film from substrate.

19. The method as in claim 17, wherein forming said one or more films comprises:
applying a cholesteric liquid crystal material blend to a curved substrate;
annealing; and
polymerizing.

20. The method as in claim 17, wherein forming said one or more films comprises:
providing a set of substrates having concave and convex film shaping surfaces, wherein at least one of the substrates is substantially transparent to permit polymerization light to pass through;
coating facing film shaping surfaces with a release layer;
over-coating the release layer with an alignment layer;
forming a cell with the substrates having surface-treated film shaping surfaces are formed a cell, optionally including spacers at peripheral edges to set the film thickness;
introducing a blend of a reactive material and a non-reactive liquid crystal material into a cell gap between the substrates;
polymerizing to form a film;
removing the non-reactive liquid crystal material thereby leaving voids at locations of previously occupied non-reactive liquid crystal material component; and
separating the film from the substrate, the film comprising a matrix of the reactive material with liquid crystal ordering.

21. The method of claim 20, further comprising filling said voids with a new component.

22. The method as in claim 17, wherein forming said one or more films comprises:
applying a blend of a reactive material and a non-reactive liquid crystal material to a curved substrate;
polymerizing to form a film; and
removing the non-reactive liquid crystal material thereby leaving voids at locations of previously occupied non-reactive liquid crystal material component.
